(19) United States
(12) Patent Application Publication
(10) Pub. No.: US 2004/0215575 A1
(43) Pub. Date: Oct. 28, 2004

(54) Efficient management of fueling transactions

(76) Inventor: John Garrity, Loxahatchee, FL (US)

Correspondence Address: J. Rodman Steele, Jr., Esq., Akerman Senterfitt, 222 Lakeview Avenue, Fourth Floor, P.O. Box 3188, West Palm Beach, FL, 33402-3188, US

(21) Appl. No.: 10/425,073

(22) Filed: Apr. 28, 2003

(51) Int. Cl. G06F 17/60

(52) U.S. Cl. 705/64

(57) ABSTRACT

A method of doing business can be provided in accordance with the present invention. The method of doing business can include converting credit card customers of a fuel service station to cash customers of the fuel service station by utilizing a biometric sensor at a POS location in the fuel service station to store biometric data for selected ones of the credit card customers. Subsequently, a fuel pump can be activated for each cash customer who submits to a biometric scan at the fuel pump and where the biometric scan produces data which when compared to the stored biometric data, qualifies the cash customer. Additionally, a purchase transaction can be consummated for dispensed fuel at the fuel pump by requiring the cash customer remit cash payment for the dispensed fuel at the POS location.

### BACKGROUND OF THE INVENTION

1. Statement of the Technical Field

The subject invention pertains to gasoline stations, which today often have convenience stores or food marts associated therewith.

2. Description of the Related Art

In most states throughout the United States, self-service in gasoline stations has become commonplace. Except in some states, such as New Jersey, where self-service is not permitted by law, the majority of customers who typically carry credit cards are permitted to use their credit cards at the pump, and are in fact able to complete a gas purchase transaction at the pump without the necessity of interacting with an attendant in either the gas station office or in a food mart location on the premises. Still, credit card processing can be cumbersome in many respects and accordingly, some have sought after alternative payment methods.

As an example, Exxon-Mobil Corporation introduced SPEEDPASS™ technology in an effort to obviate the need to manually process a credit card transaction, while simultaneously creating brand loyalty in respect to credit services offered by Exxon-Mobil Corporation and their financing affiliates. Yet, the use of SPEEDPASS technology entirely eliminates the need for a customer to visit an on-site convenience store, and in fact encourages customers never to visit an on-site convenience store. While in most cases, customers would prefer to consummate an entire transaction at the pump, such consumer behavior can inhibit in-store sales sorely needed by gas station operators. Moreover, the use of SPEEDPASS technology in of itself may generate brand loyalty, but seldom will generate gas station loyalty. That is, one gas station franchise can seem indistinguishable from the next station of the same franchise from the consumer perspective. Once again, while convenient for the customer, the franchisee relies upon gas station loyalty for survival.

Biometric data collections devices, like SPEEDPASS technology, represent a new alternative to the conventional credit card when consummating sales transactions. In specific respect to gasoline sales, U.S. Pat. No. 5,862,222 discloses the use of biometric data such as a fingerprint to enable a vehicle to be fueled at a robot station. Similarly, United States Patent Application Publications 2003-0028284 and 2002-0188574 disclose systems where a fingerprint or other biometric data may be utilized at a gasoline pump to ensure proper accountability albeit the biometric data in such publications are not used to consummate a transaction. Hence, while the ability to use biometric data in place of a credit card or to ensure greater accountability with respect to credit card use, are well within today's technology, the use of biometric data has not been used to facilitate what Would otherwise be a straight cash transaction.

The skilled artisan having an ordinary understanding of gasoline station management will attest to the paradox of pay-at-the-pump operations. Specifically, while it remains-technically feasible by way of credit-card technology to consummate a gasoline purchase transaction exclusively at the pump, to obviate the need for a consumer to enter an associated convenience store as part of the transaction can hinder additional convenience store sales. By comparison, in a cash transaction for the purchase of gasoline the consumer will be required to “pay first” at the cashier prior to pumping fuel in order to ensure payment for the same. In consequence, where the cashier has been strategically positioned within a convenience store, additional non-fuel related, higher margin sales will be encouraged. Yet, to consummate a cash transaction will require two trips minimally into the convenience store-offering twice the opportunity for the gas station convenience store to generate additional sales, but doubly inconveniencing the consumer.

### SUMMARY OF THE INVENTION

It is an object of the subject invention to reduce the cumbersome nature of cash transactions at gasoline service stations.

It is a further object of the subject invention to better serve cash customers by not subjecting them to an undue burdensome transaction in the purchasing of gasoline.

It is yet another object of the subject invention to encourage cash use over credit card use, as there are advantages for both customer and retail fuel center.

It is still yet another object of the present invention to use biometric identification techniques to facilitate otherwise routine service station transactions.

It is but another object of the subject invention by using biometric techniques to substantially reduce fuel pump time, as defined by when the driver pulls to the pump and which extends to the time he drives away from the pump. Multiple trips to a remote fuel attendant prolong such periods of time.

It is yet but another object of the subject invention to decrease the potential of fraud and theft at a gasoline service station.

It is still one more object of the subject invention to create means of encouraging customer loyalty to individual service stations or to gasoline companies.

Finally, it is another object of the present invention to develop an improved method of doing business or system that will simplify retail use, and be useful for fleet fueling.

Consistent with the above objects, the subject invention is directed to a system and method which will likely convert credit card customers of a gasoline service station to cash customers by simplifying the transaction for approved cash customers. Once a person has been identified as qualified, and once that person's biometric identity has been established, a fueling pump can be automatically activated for use when a customer engages a biometric sensor at a pump location. In consequence, the customer can proceed to check out once the customer has finished fueling at which point the customer can remit payment for the transaction or can otherwise acknowledge the transaction in anticipation of future payment.

Notably, in applying biometric processing of a fueling transaction, customers are not encouraged to overfill their respective fuel tanks. Moreover, by avoiding excessive overfill, fuel-spills are eliminated, and the damage to vapor recovery systems is minimized. A variation of the foregoing process can be particularly valuable for fleet fueling, as for instance, taxicabs, trucks, and the like. For example, an employee of a customer with a house/credit account who has been previously identified biometrically, can position a vehicle proximate to the fuel pump. The employee can engage the biometric sensor, alerting the cashier as to the identity of the account to enable the cashier to activate the fuel pump. Such process can decrease the fraud/theft possibility with respect to the business customer. More specifically, one can more easily prove that the sale actually occurred and that the employee received the gas.

In an alternative embodiment, the subject invention can facilitate the establishment of grocery-membership clubs. In this regard, when a customer purchases merchandise, as for example in a service station convenience store, the customer may also wish to purchase gasoline. Unfortunately, the customer will not know at which pump the fueling will occur, but the customer can use the biometric sensor at the checkout location to establish their identity. At that time, a proposed sale amount can be held in memory until the customer selects a particular fuel pump. Upon engaging the biometric sensor at the selected fuel pump, it will become readily apparent to the system at which fuel pump to apply the proposed sale. Advantages of process and system of the present invention include the improvement of the functionality and management of the fuel purchasing transaction. Discounts for fuel can be applied readily, as for example with respect to customer loyalty rewards.

The subject method and system of the invention can be enabled within the gas station retail center, which can include a convenience store. The system invariably can include a biometric sensor proximately positioned about a point of sale location. Additionally, a biometric sensor can be proximately positioned to selected fuel pumps. A fuel control system further can be disposed at one or both of the point of sale location and the fuel pumps, as can a database of biometric data. Finally, integration logic can process captured biometric data to activate and deactivate selected fuel pumps at the gas station retail center.

A method for purchasing fuel can include the steps of/qualifying a particular customer as trusted by establishing a biometric identity for the particular customer for use in future sales. Subsequently, the particular customer can be biometrically identified at a fuel pump. Finally, the biometrically identified customer can be permitted to dispense fuel at the fuel pump without requiring the biometrically identified customer to pre-pay in order to dispense the fuel. Notably, an account can be credited for the biometrically identified customer based upon a quantity of fuel dispensed by the biometrically identified customer responsive to the permitting step. Alternatively, cash payment can be accepted for the biometrically identified customer based upon a quantity of fuel dispensed by the biometrically identified customer responsive to the permitting step.

Importantly, a method of doing business can be provided in accordance with the present invention. The method of doing business can include converting credit card customers of a fuel service station to cash customers of the fuel service station by utilizing a biometric sensor at a POS location in the fuel service station to store biometric data for selected ones of the credit card customers. Subsequently, a fuel pump can be activated for each cash customer who submits to a biometric scan at the fuel pump and where the biometric scan produces data which when compared to the stored biometric data, qualifies the cash customer. Additionally, a purchase transaction can be consummated for dispensed fuel at the fuel pump by requiring the cash customer remit cash payment for the dispensed fuel at the POS location.

### BRIEF DESCRIPTION OF THE FIGURES AND ILLUSTRATIONS

There are shown in the drawings embodiments which are presently preferred, it being understood, however, that the invention is not limited to the precise arrangements and instrumentalities shown, wherein:

FIG. 1 is a schematic illustration of a system for managing fueling transactions which has been configured with a biometric sensing apparatus in accordance with one aspect of the inventive arrangements;

FIG. 2 is a flow chart illustrating a process for managing a fueling transaction in the system of FIG. 1;

FIG. 3 is a flow chart illustrating a process for validating the purchase of fuel in the system of FIG. 1; and,

### DETAILED DESCRIPTION OF THE INVENTION

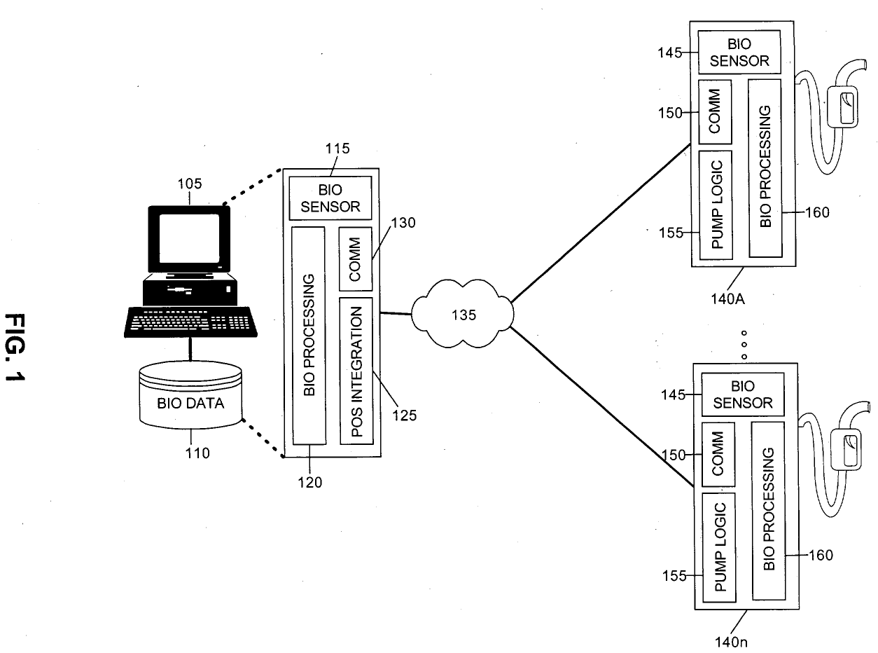

FIG. 1 is a schematic illustration of a system for managing fueling transactions which has been configured with a biometric sensing apparatus in accordance with one aspect of the inventive arrangements. The system can include a centralized computing entity 105 coupled to a persistent store 110 of biometric data. In this regard, the centralized computing entity 105 can range from a comprehensive point of sale (POS) system, to merely a simplified fuel control system (not shown) in which authorized customers are permitted to dispense fuel in exchange for payment. Generally, it is anticipated that such centralized computing entity 105 can be disposed in POS location such as at a cash register within a convenience store at a gas station retail center. Still, the invention is not limited strictly to a single location, and in alternative embodiments, the centralized computing entity 105 can include one or more distributed devices both on-site and off which, when combined, form the centralized computing entity 105.

In any case, the centralized computing entity 105 can be coupled via POS integration logic 125 to a biometric sensor 115. The biometric sensor 115 can include a scanning device configured to scan human biological features, such as a finger or thumb print, retinal characteristics and the like. Based upon a scanning of such biological features, an identifying data stream can be produced which correlates specific aspects of the scanned biological features to digital data such as a human identity. In the present invention, identifying data stream and correlative identity information can be stored in the persistent store 110 of biometric data. Once stored, biometric processing logic 120 can match newly scanned biological features to those biological features which have been previously stored in the persistent store 110 of biometric data.

Notably, the centralized computing entity 105 can be communicatively coupled to fuel pumps 140A . . . 140n over a computer communications network 135. The communicative coupling can range from direct wireline or wireless links, to a more sophisticated wireline or wireless network such as is known in the art. Each of the fuel pumps 140A . . . 140n can be accessed through communications interface 150, as can the centralized computing entity 105 through communications interface 130. More specifically, the centralized computing entity 105 can exchange messages with the fuel pumps 140A . . . 140n, for instance “OK to activate pump” messages, and “Identity Invalid” messages.

Each fuel pump 140A . . . 140n additionally can include pump logic 155 and biometric data processing logic 160. The biometric data processing logic 160 can be coupled to a biometric sensor 145 so as to maintain a processing ability for biometric data collected at the fuel pump 140A . . . 140n. In particular, the biometric data collected at the fuel pump 140A . . . 140n can be processed to produce an identifying data stream. Optionally, the biometric data processing logic can activate and deactivate the pump 140A . . . 140n via pump logic 155 without accessing the centralized computing entity 105. In this case, a local copy of the persistent store 110 can be retained at each fuel pump 140A . . . 140n as is known in the field of distributed POS systems. Yet, in a preferred aspect of the invention, biometric data collected at the fuel pump 140A . . . 140n can be processed centrally in the centralized computing entity 105 over the computer communications network 135.

In operation, customers initially can register their identity with the centralized computing entity 105 by submitting to a biometric scan of a selected biological feature such as a thumb print. The biometric data processing logic 120 can produce an identifying data stream for the scanned feature and can correlate the data with the identity of the customer. The data stream and identity can be stored in the persistent store 110. Additionally, associated account data, such as remaining credit, a credit card number, frequent shopping data and the like can be stored in association with the identity.

During subsequent visits to the gas station, the customer can submit to a biometric scan at the fuel pump 140A . . . 140n. The fuel pump 140A. 140n, in turn, can produce the requisite data stream and can determine whether a match exists between the data stream produced at the fuel pump 140A . . . 140n and that which had been produced initially at the centralized computing entity 105. Where a match exists and further where it is determined that the customer can purchase fuel on the strength of trust, the fuel pump 140A . . . 140n can be activated and the customer can be permitted to dispense fuel as requested. Subsequently, the fuel purchase transaction can be consummated by the customer visiting the cash register to pay cash, or a personal account can be debited for frequent fuelers. It will be recognized by the skilled artisan that in consequence of the present invention, the customer need only visit the cash register once for a cash register rather than twice as would have been the case in a conventional arrangement.

The subject system is beneficial to both retail fuel center operators and the customer. With respect to the retail fuel operator, customers can move through the system faster than previously possible, which enables the retail fuel center to eliminate lines and thus attract more customers. As for the customer, the is able to purchase gas and retail items much more expeditiously and is also able to use cash and not be forced to engage in a credit card transaction simply for the purpose of expediting the service. By installing the system, gas station owners are able to give preferential treatment to customers, including discounts, which in addition to the faster service possible, has the added advantage of developing customer loyalty, as satisfied customers will want to purchase gas and retail items at locations where the fingerprint system is available.

The system of FIG. 1 can permit a variety of business activities to improve the business of the retail fuel center. For example, merchandise membership clubs can be facilitated, which is particularly beneficial with respect to the food mart/gas station combination. A customer may buy merchandise and fuel as he goes through the checkout line prior to pulling to the pump. While at the checkout line he engages the fingerprint/thumbprint sensor whereby the sale amount will be held in the database until the customer pulls to a gas pump and engages a fingerprint/thumbprint sensor at the pump. The pump will be authorized to complete the sale, which simplifies the transaction in permitting the customer to go to any pump that is available, which would not have been possible otherwise. This system allows the retail fuel center to give discounts and customer loyalty rewards to its customers.

Additionally, to encourage customers to engage in a cash payment transaction rather than a credit card transaction, a cash rebate can be applied to a purchase transaction satisfied in cash. More particularly, as a credit card surcharge often can cost in excess of five cents per gallon in processing fees, all or a portion of the surcharge can be shared with the customer. Alternatively, the customer can receive merchandise gift incentives from an on-site convenience store or other retail outlet associated with the gas station.

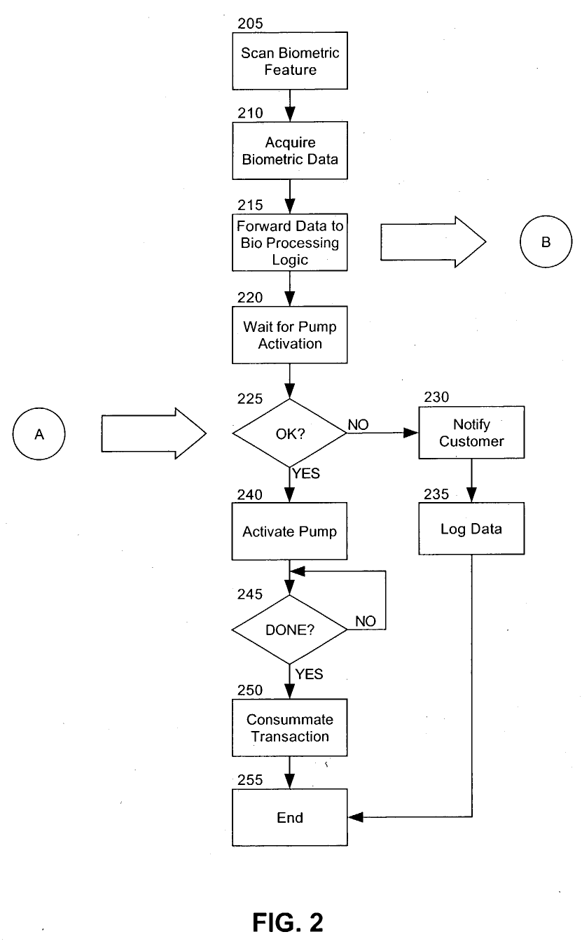

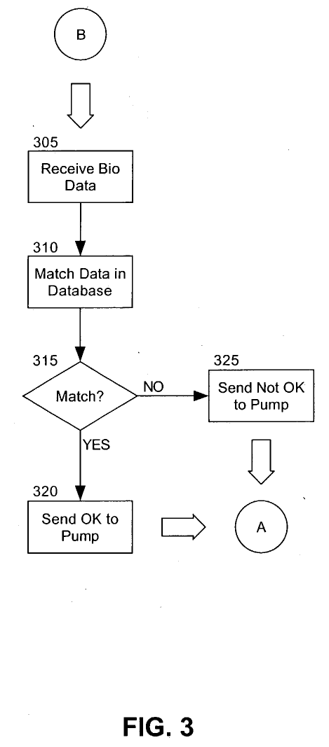

FIG. 2 is a flow chart illustrating a process for managing a fueling transaction in the fuel pump of the system of FIG. 1. Beginning in block 204, a biometric feature of the customer can be scanned. In block 210, biometric data can be produced for the scan. In block 215, the biometric data can be forwarded to the biometric data processing logic and in block 220 the pump can await a response from the biometric data processing logic. The biometric data processing logic, in turn, can determine whether the pump can be activated based upon the determined identity of the customer. In this regard, FIG. 3 is a flow chart which illustrates a process for validating the purchase of fuel based upon biometrically correlated data.

Beginning in block 305, the biometric data can be received from the pump. In block 310, a persistent data store of biometric data can be searched for a matching entry. In decision block 315, if a match exists, in block 320 the pump can be authorized to permit fuel dispensing subject only any restrictions specified in association with the matched identity. Otherwise, in block 325, the pump can be instructed to prohibit the dispensing of fuel as the customer will not have been recognized as a “trusted” customer who had previously submitted to a pre-authorization process. In either case, returning to FIG. 2, in decision block 225, if it is determined that the customer had not been authorized to dispense fuel, in block 230 the customer can be so notified and the event can be logged for subsequent audit.

If, however, in decision block 225 it is determined that the customer has been authorized to dispense fuel, in block 240 the fuel pump can be activated. The customer can proceed to dispense fuel and the process can loop through decision block 245 until it is determined that the customer has completed the fueling process. Once the customer has completed the fueling process, in block 250 the transaction can be consummated. In this respect, the customer can remit payment directly to the cashier. Alternatively, where the customer has established an account on store credit with the gas station, the customer's account can be credited for the transaction. Finally, in block 255 the process can end.

The method of the present invention can be realized in hardware, software, or a combination of hardware and software. An implementation of the fuel transaction method of the present invention can be realized in a centralized fashion in one computer system, or in a distributed fashion where different elements are spread across several interconnected computer systems. Any kind of computer system, or other apparatus adapted for carrying out the methods described herein, is suited to perform the functions described herein.

A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system is able to carry out these methods.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

What is claimed is:

1. A method for purchasing fuel comprising the steps of:
qualifying a particular customer as trusted by establishing a biometric identity for said particular customer for use in future sales;
subsequently biometrically identifying said particular customer at a fuel pump; and,
permitting said biometrically identified customer to dispense fuel at said fuel pump without requiring said biometrically identified customer to pre-pay in order to dispense said fuel.

2. The method of claim 1, further comprising the step of crediting an account for said biometrically identified customer based upon a quantity of fuel dispensed by said biometrically identified customer responsive to said permitting step.

3. The method of claim 1, further comprising the step of collecting cash payment for said biometrically identified customer based upon a quantity of fuel dispensed by said biometrically identified customer responsive to said permitting step.

4. The method of claim 1, wherein said step of biometrically identifying said particular customer comprises the steps of:
biometrically scanning one of a fingerprint and a retina of said particular customer; and,
digitally characterizing said biometric scan to produce a data stream of identifying data.

5. A method of doing business, including converting credit card customers of a fuel service station to cash customers of the fuel service station by utilizing a fuel purchasing process comprising the steps of:
utilizing a biometric sensor at a point of sale (POS) location in the fuel service station to store biometric data for selected ones of the credit card customers; and,
activating a fuel pump for each cash customer who submits to a biometric scan at said fuel pump and wherein said biometric scan produces data which when compared to said stored biometric data, qualifies said cash customer.

6. The method of claim 5, further comprising the step of consummating a purchase transaction for dispensed fuel at said fuel pump by requiring said cash customer to remit cash payment for said dispensed fuel at said POS location.

7. The method of claim 6, further comprising the step of providing a cash rebate to selected ones of the credit card customers less than or equal to a cash amount equivalent to a credit card processing fee which would accrue when processing a credit card payment for said dispensed fuel.

8. The method of claim 6, further comprising the step of providing free merchandise to selected ones of the credit card customers said merchandise having a value of less than or equal to a cash amount equivalent to a credit card processing fee which would accrue when processing a credit card payment for said dispensed fuel.

9. A biometric fuel dispensing system comprising:
a POS terminal;
a database of biometric data communicatively linked to said POS terminal;
a biometric sensor and corresponding biometric data processor communicatively linked to said database and configured to produce an identifying data stream for biometric data collected in said biometric sensor;
at least one remote biometric sensor and corresponding biometric data processor disposed proximately to a fuel pump and communicatively linked to said database; and,
pump logic coupled to said fuel pump and configured to activate said fuel pump responsive to verifying an identity of a customer by matching an identifying data stream produced by biometric data collected by said remote biometric sensor to an identifying data stream stored in said database.

10. A machine readable storage having stored thereon a computer program for authorizing a fuel purchase transaction, the computer program comprising a routine set of instructions for causing the machine to perform the steps of:
qualifying a particular customer as trusted by establishing a biometric identity for said particular customer for use in future sales;
subsequently biometrically identifying said particular customer at a fuel pump; and,
permitting said biometrically identified customer to dispense fuel at said fuel pump without requiring said biometrically identified customer to pre-pay in order to dispense said fuel.

11. The machine readable storage of claim 10, further comprising the step of crediting an account for said biometrically identified customer based upon a quantity of fuel dispensed by said biometrically identified customer responsive to said permitting step.

12. The machine readable storage of claim 10, further comprising the step of collecting cash payment for said biometrically identified customer based upon a quantity of fuel dispensed by said biometrically identified customer responsive to said permitting step.

13. The machine readable storage of claim 10, wherein said step of biometrically identifying said particular customer comprises the steps of:
biometrically scanning one of a fingerprint and a retina of said particular customer; and,
digitally characterizing said biometric scan to produce a data stream of identifying data.
